(19) United States
(12) Patent Application Publication
(10) Pub. No.: US 2016/0042395 A1
(43) Pub. Date: Feb. 11, 2016

(54) ADVERTISEMENT INFORMATION DISTRIBUTION DEVICE, CLIENT TERMINAL ADVERTISEMENT INFORMATION DISTRIBUTION METHOD, AND ADVERTISEMENT INFORMATION PRESENTING METHOD

(71) Applicant: MITSUBISHI ELECTRIC CORPORATION, Tokyo (JP)

(72) Inventors: Atsushi MATSUMOTO, Tokyo (JP); Takuji MORIMOTO, Tokyo (JP); Yasutaka KONISHI, Tokyo (JP); Shinji AKATSU, Tokyo (JP); Kiyoshi MATSUTANI, Tokyo (JP)

(73) Assignee: MITSUBISHI ELECTRIC CORPORATION, Tokyo (JP)

(21) Appl. No.: 14/782,001

(22) PCT Filed: Apr. 25, 2013
(86) PCT No.: PCT/JP2013/062262

§ 371 Date: Oct. 2, 2015

(51) Int. Cl. G06Q 30/02

(52) U.S. Cl. CPC G06Q 30/0261; G06Q 30/0267; G06Q 30/0277

(57) ABSTRACT

An advertisement information distribution device 2 receives an advertisement information distribution request including manufacturer information from a client terminal via a communicator 23, and distributes advertisement information. Because the distribution destination terminal information manager 24 manages the manufacturer information about the client terminal to which the advertisement information is distributed, the number of distributions of advertisement information can be counted for each manufacturer, and the advertising cost can be shared out among manufacturers according to the number of distributions to the manufacturers and monetary merits can be provided for the manufacturers.

### FIELD OF THE INVENTION

The present invention relates to an advertisement information distribution device that distributes advertisement information about a facility existing in the surroundings of a client terminal which is carried by the user, and an advertisement information distribution method for use in the advertisement information distribution device, and a client terminal that receives distribution of advertisement information and an advertisement information presenting method for use in client terminal.

### BACKGROUND OF THE INVENTION

A method of providing advertisement information, such as a coupon, for a client terminal which is carried by a user when the user gets close to a commercial facility such as a specific shop is known. For example, patent reference 1 discloses an advertisement information providing device that displays a route from a place of departure to a destination and advertisement information associated with the route on a terminal device. Further, patent reference 2 discloses a technique of narrowing down advertisements on a map screen which is displayed, via the Internet, on a user terminal by using a map information providing service to advertisements matching a user's attributes, and displaying these advertisements, thereby solving a problem that advertisements other than desired advertisements are displayed. Further, patent reference 3 discloses a server device that transmits incentive information, such as a coupon, in response to a request from a user terminal, and that counts and stores the transmission number of times of incentive information for each provider that provides incentive information, and proposes a technique of allowing an advertising company that manages the server device to charge each provider on the basis of this transmission number of times.

### RELATED ART DOCUMENT

### Patent Reference

Patent reference 1: Japanese Unexamined Patent Application Publication No. 2012-185168

Patent reference 2: Japanese Unexamined Patent Application Publication No. 2001-216236

Patent reference 3: Japanese Unexamined Patent Application Publication No. 2012-243067

### SUMMARY OF THE INVENTION

### Problems to be Solved by the Invention

In the techniques disclosed in above-mentioned patent references 1 to 3, even if an appropriate advertisement display is produced on a client terminal which is carried by a user and, as a result, advertisement information, such as information for guiding the user to an advertiser's shop, is sufficiently utilized, no incentive is provided for the manufacturer of the client terminal. A problem is therefore that the manufacturer of the client terminal does not have any monetary merit and hence does not come to perform an operation of displaying advertisement information positively, and, by extension, the conventional techniques have not led to the widespread proliferation of advertisement information distribution.

The present invention is made in order to solve the above-mentioned problems, and it is therefore an object of the present invention to provide a technique of providing the manufacturer of each of client terminals with a monetary merit, thereby making client terminals that can present advertisement information become widespread.

### Means for Solving the Problem

In accordance with the present invention, there is provided an advertisement information distribution device including: an advertisement database to store pieces of advertisement information and pieces of position information about facilities of advertisers which provide the above-mentioned pieces of advertisement information, respectively, while linking the pieces of advertisement information and the pieces of position information with each other; an advertisement information extractor to extract advertisement information of a facility existing in a predetermined range from a client terminal from the advertisement database on the basis of position information about the client terminal and the pieces of position information about facilities; a communicator to receive a distribution request including the position information about the client terminal and manufacturer information showing the manufacturer of the client terminal from the client terminal, and to distribute the advertisement information which the advertisement information extractor extracts according to the above-mentioned position information; and a distribution destination terminal information manager to hold the manufacturer information about the client terminal to which the advertisement information distribution device distributes the advertisement information.

In accordance with the present invention, there is provided a client terminal including: a position information acquirer to acquire position information about the client terminal itself; a terminal information manager to store manufacturer information showing the manufacturer of the client terminal itself; a communicator to transmit the position information which the position information acquirer acquires and the manufacturer information which the terminal information manager stores to an advertisement information distribution device, and to make a request to distribute advertisement information of a facility existing in a predetermined range from the client terminal itself, and to receive the advertisement information which is distributed thereto from the advertisement information distribution device in response to the above-mentioned request; and an advertisement information presenter to present the advertisement information which the communicator receives.

In accordance with the present invention, there is provided an advertisement information distribution method including: an advertisement information distribution request receiving step of receiving a distribution request including position information about a client terminal and manufacturer information showing the manufacturer of the client terminal; an advertisement information extracting step of extracting advertisement information of a facility existing in a predetermined range from the client terminal from which the distribution request is received from an advertisement database to store pieces of advertisement information and pieces of position information about facilities of advertisers which provide the above-mentioned pieces of advertisement information, respectively, while linking the pieces of advertisement information and the pieces of position information with each other; an advertisement information distributing step of distributing the advertisement information extracted in the advertisement information extracting step to the client terminal; and a distribution destination terminal information managing step of holding the manufacturer information about the client terminal to which the advertisement information is distributed in the advertisement information distributing step.

In accordance with the present invention, there is provided an advertisement information presenting method including: a position information acquiring step of a mobile terminal acquiring position information about a client terminal; an advertisement information distribution requesting step of the mobile terminal acquiring manufacturer information showing the manufacturer of the client terminal from the client terminal, transmitting the manufacturer information to an advertisement information distribution device together with the position information acquired in the position information acquiring step, and making a request to distribute advertisement information of a facility existing in a predetermined range from the client terminal; an advertisement information receiving step of the mobile terminal receiving the advertisement information which is distributed thereto from the advertisement information distribution device in response to the request; and an advertisement information presenting step of the mobile terminal outputting the advertisement information received in the advertisement information receiving step to the client terminal, and the client terminal presenting the advertisement information.

### Advantages of the Invention

In accordance with the present invention, because each client terminal transmits an advertisement information distribution request including the manufacturer information about the client terminal itself, and the advertisement information distribution device distributes advertisement information in response to the request while holding the manufacturer information, thereby making it possible to share out an advertising cost according to the number of distributions among the manufacturers of client terminals, and to provide a monetary merit for each of the client terminals, client terminals that can present advertisement information can be made to become widespread.

### BRIEF DESCRIPTION OF THE FIGURES

FIG. 1 is a block diagram showing the entire configuration of an advertisement information distribution system in accordance with Embodiment 1 of the present invention;

FIG. 2 is a block diagram showing the configuration of a client terminal in accordance with Embodiment 1;

FIG. 3 is a diagram showing an example of terminal information which is managed by a terminal information manager of a client terminal in accordance with Embodiment 1;

FIG. 4 is a block diagram showing the configuration of an advertisement information distribution device in accordance with Embodiment 1;

FIG. 5 is a diagram showing an example of advertisement information transmitted and received in the advertisement information distribution system in accordance with Embodiment 1;

FIG. 6 is a diagram showing an example of distribution destination terminal information which is managed by an distribution destination terminal information manager of the advertisement information distribution device in accordance with Embodiment 1;

FIG. 7 is a flow chart showing the operation of the advertisement information distribution system in accordance with Embodiment 1;

FIG. 8 is a block diagram showing the configuration of an advertisement information distribution device in accordance with Embodiment 2 of the present invention;

FIG. 9 is a diagram showing an example of distribution destination terminal information which is managed by a distribution destination terminal information manager of the advertisement information distribution device in accordance with Embodiment 2; and

FIG. 10 is a flow chart showing the operation of the advertisement information distribution system in accordance with Embodiment 2.

### EMBODIMENTS OF THE INVENTION

Hereafter, in order to explain this invention in greater detail, the preferred embodiments of the present invention will be described with reference to the accompanying drawings. Embodiment 1.

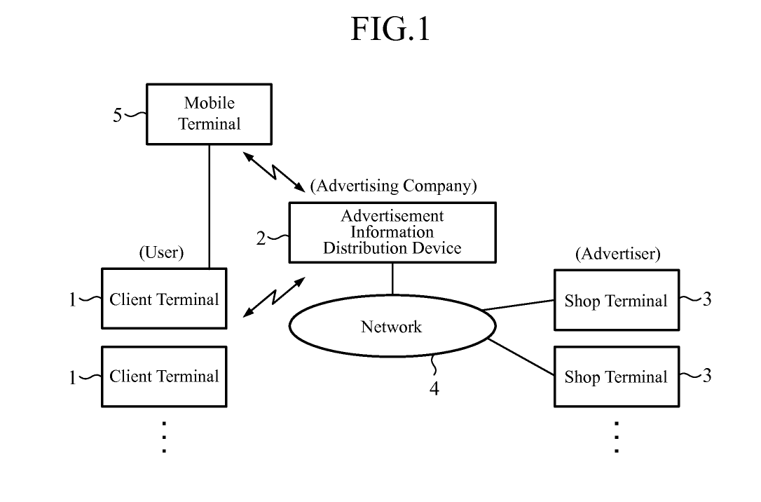

As shown in FIG. 1, an advertisement information distribution system in accordance with this Embodiment 1 is configured with a plurality of client terminals 1, an advertisement information distribution device 2, a plurality of shop terminals 3, a network 4, and a mobile terminal 5.

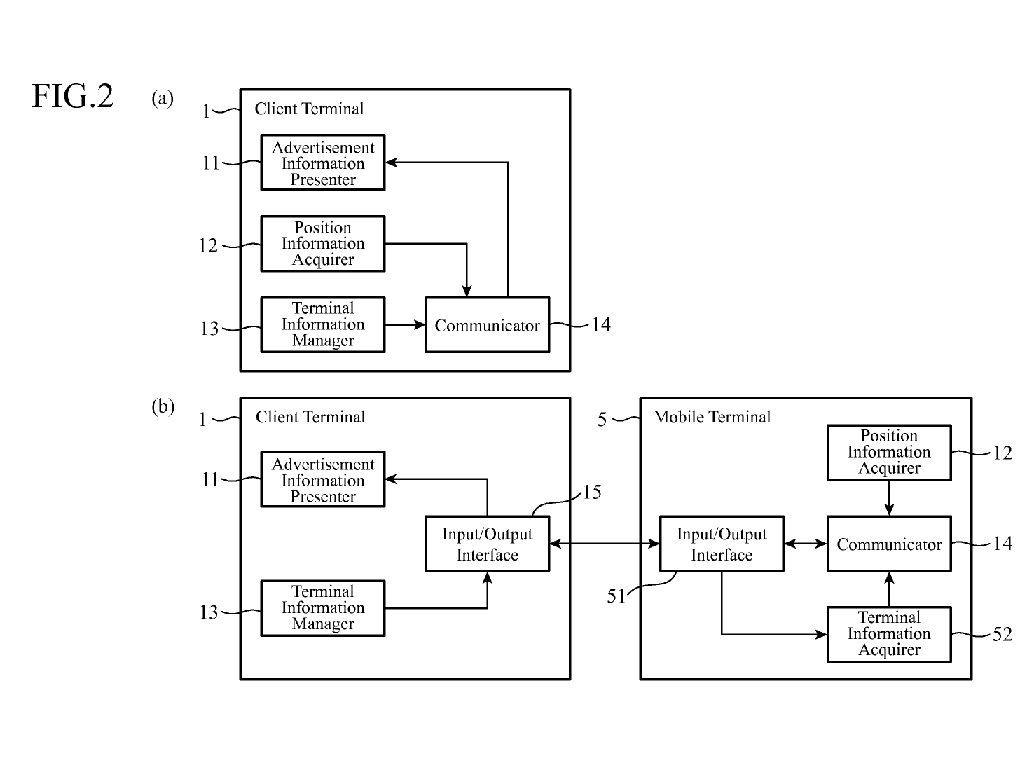

FIG. 2(a) is a block diagram showing the configuration of a client terminal 1. The client terminal 1 is, for example, a mobile phone or a smart phone which a user carries, or a navigation device or the like which can be mounted or carried in a moving object (e.g., a vehicle), and can communicate with the advertisement information distribution device 2 by radio. This client terminal 1 includes an advertisement information presenter 11, a position information acquirer 12, a terminal information manager 13, and a communicator 14.

A description about FIG. 2(b) will be made below.

The advertisement information presenter 11 presents advertisement information received from the advertisement information distribution device 2 to the user. As a presenting method, a method of displaying the advertisement information on a screen disposed in the client terminal 1 as text information or image information, or a method of generating an audio output of the advertisement information from a speaker disposed in the client terminal 1 can be used. The position information acquirer 12 acquires the current position of the client terminal 1. For example, the position information acquirer receives GPS (Global Positioning System) signals to specify the current position (e.g., latitude and longitude). The terminal information manager 13 manages terminal information including at least manufacturer information making it possible to identify the manufacturer of the client terminal 1. The communicator 14 communicates with the advertisement information distribution device 2 by radio.

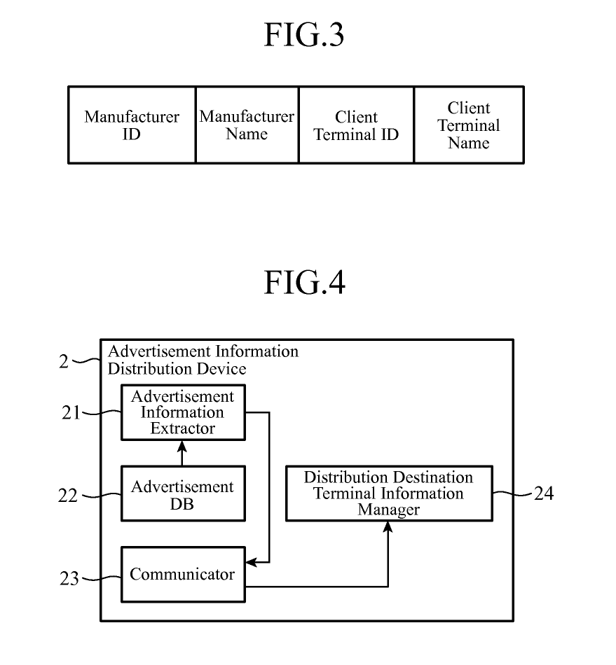

Hereafter, an example of the terminal information which the terminal information manager 13 manages is shown in FIG. 3. The terminal information includes a manufacturer ID uniquely showing the manufacturer that manufactures the client terminal 1, the name of the manufacturer, a client terminal ID uniquely showing the client terminal 1, and the name of the client terminal. In the terminal information in this example, the manufacturer ID corresponds to manufacturer information.

When a client terminal 1 makes a request for the advertisement information of a shop existing in an area surrounding the current position thereof, the client terminal makes the request by combinedly transmitting the current position information which the position information acquirer 12 acquires and the terminal information which the terminal information manager 13 manages (e.g., the client terminal ID and the manufacturer ID) from the communicator 14 to the advertisement information distribution device 2. The client terminal receives the advertisement information distributed thereto from the advertisement information distribution device 2 by using the communicator 14, and the advertisement information presenter 11 presents the advertisement information to the user.

FIG. 4 is a block diagram showing the configuration of the advertisement information distribution device 2. The advertisement information distribution device 2 is a server or the like which is managed by an advertising company, and accepts advertisement information from an advertiser's shop terminal 3 via the network 4 and distributes the advertisement information in response to a distribution request from each client terminal 1. This advertisement information distribution device 2 includes an advertisement information extractor 21, an advertisement database (abbreviated as DB from here on) 22, a communicator 23, and a distribution destination terminal information manager 24.

The advertisement information extractor 21 extracts advertisement information from the advertisement DB 22 in response to an advertisement information distribution request received from each client terminal 1, and transmits the advertisement information to the client terminal 1 via the communicator 23. The advertisement DB 22 stores shop information about and advertisement information of a shop which are received from each shop terminal 3. The communicator 23 communicates with each client terminal 1 by radio, and also communicates with each shop terminal 3 via the network 4. The distribution destination terminal information manager 24 stores the terminal information received from each client terminal 1 and the advertisement information which has been distributed to the client terminal while linking the terminal information and the advertisement information with each other.

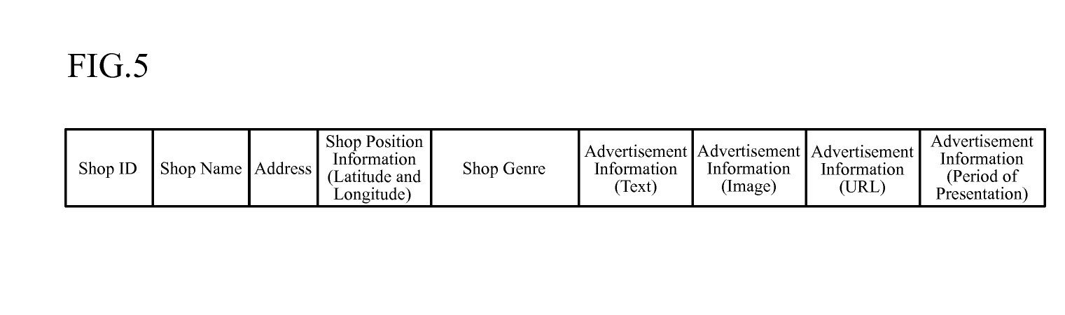

An example of each advertisement information transmitted and received in the advertisement information distribution system is shown in FIG. 5. This advertisement information is generated by a shop terminal 3 and is transmitted to the advertisement information distribution device 2, and is then stored in the advertisement DB 22 of the advertisement information distribution device 2 and is distributed to each client terminal 1 as needed. This advertisement information includes a text in which advertisement contents are described, an image, the URL (Uniform Resource Locator) of a website, and a period of presentation during which this advertisement information is valid. Further, as the shop information, a shop ID uniquely showing the shop in which the shop terminal 3 is placed, the name of the shop, the address of the shop, the position information about the shop (e.g., latitude and longitude), and the genre of the shop are included.

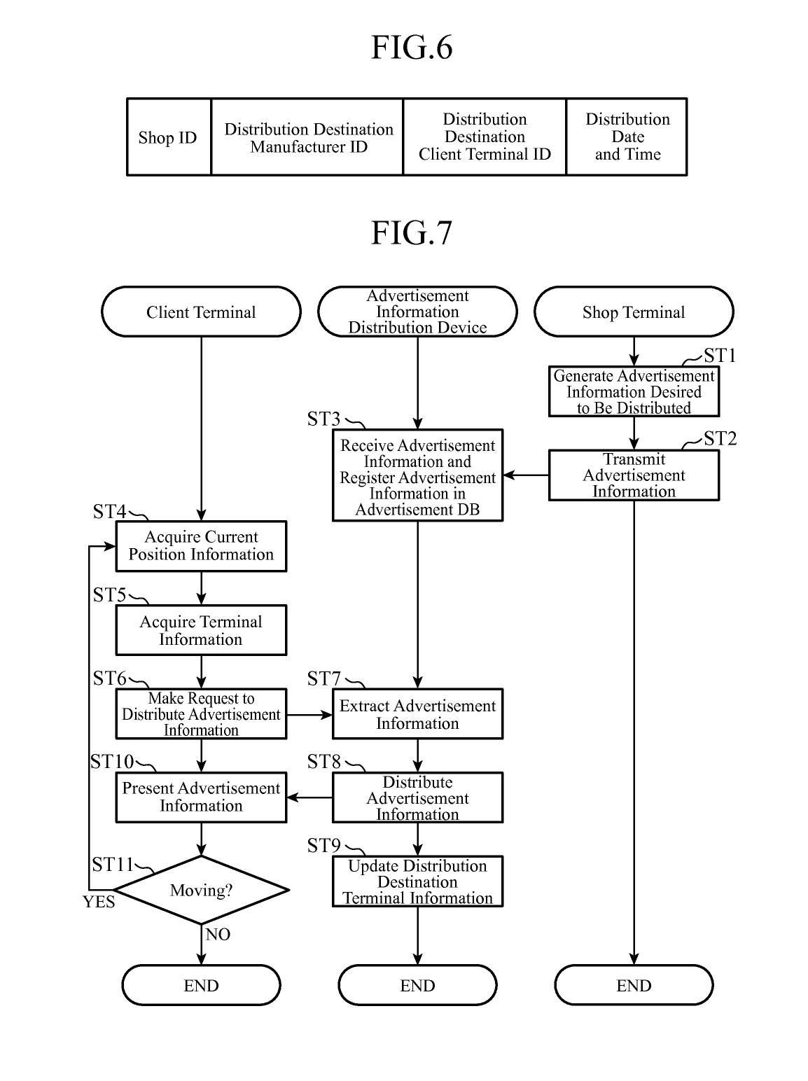

An example of each distribution destination terminal information which the distribution destination terminal information manager 24 manages is shown in FIG. 6. Each distribution destination terminal information includes the shop ID of the shop terminal 3 which is the provider of advertisement information distributed to a client terminal 1, the distribution destination manufacturer ID which is the manufacturer ID of the client terminal 1, the distribution destination client terminal ID which is the client terminal ID of the client terminal 1, and the distribution date and time.

Each shop terminal 3 is a terminal device (e.g., a personal computer) placed in a shop, a commercial facility, or the like of an advertiser which provides advertisement information, and can communicate with the advertisement information distribution device 2 via the network 4. This shop terminal 3 transmits the shop information and the advertisement information as shown in FIG. 5 to the advertisement information distribution device 2 via the network 4.

Next, the operation of the advertisement information distribution system will be explained by using a flow chart of FIG. 7.

An advertiser, in step ST1, operates a shop terminal 3 to generate advertisement information (e.g., that shown in FIG. 5) to be distributed to the client terminals 1. Next, the shop terminal 3, in step ST2, transmits the advertisement information to the advertisement information distribution device 2. The communicator 23 of the advertisement information distribution device 2, in step ST3, receives the advertisement information and registers this advertisement information in the advertisement DB 22. The above steps ST1 to ST3 can be performed as needed.

When a client terminal 1 makes a request to distribute advertisement information, the position information acquirer 12, in step ST4, acquires the current position information first. Next, the communicator 14, in step ST5, acquires the terminal information (e.g., that shown in FIG. 3) from the terminal information manager 13, and, in step ST6, combines the terminal information and the position information to transmit an advertisement information distribution request to the advertisement information distribution device 2. It is assumed hereafter that the terminal information to be transmitted includes at least the manufacturer ID showing the manufacturer of the client terminal 1.

Step ST4 corresponds to a position information acquiring step, and steps ST5 and ST6 correspond to an advertisement information distribution requesting step.

When the communicator 23 of the advertisement information distribution device 2, in step ST7, receives the advertisement information distribution request from the client terminal 1, the advertisement information extractor 21 extracts advertisement information from the advertisement DB 22. At that time, from the advertisement DB 22 in which pieces of advertisement information each having contents as shown in, for example, FIG. 5 are registered, the advertisement information extractor 21 extracts pieces of advertisement information respectively including pieces of shop position information which satisfy a fixed distance range on the basis of the position information about the client terminal 1.

Step ST7 corresponds to an advertisement information distribution request receiving step and an advertisement information extracting step.

Further, in addition to the above-mentioned criterion, the advertisement information extractor 21 can add a criterion that the period of presentation of each advertisement information to be extracted does not expire, for example. Further, when information about the shop genre which the user desires is included in the advertisement information distribution request from the client terminal 1, the advertisement information extractor 21 can extract pieces of advertisement information from the advertisement DB 22 while narrowing down the extraction to the shop genre.

The advertisement information distribution device, in next step ST8, distributes the pieces of advertisement information which the advertisement information extractor 21 has extracted from the advertisement DB 22 in this way from the communicator 23 to the client terminal 1.

After that, the distribution destination terminal information manager 24, in step ST9, holds the distribution destination terminal information (e.g., that shown in FIG. 6) including the terminal information about the distribution destination (including at least the manufacturer ID), and the pieces of shop information about the shop terminals 3 which have provided the pieces of advertisement information distributed. As a result, the distribution destination terminal information manager can manage how many pieces of advertisement information of specific shops have been distributed to which one of the manufacturers of the client terminals 1.

Step ST8 corresponds to an advertisement information distributing step and step ST9 corresponds to a distribution destination terminal information managing step.

For example, the distribution destination terminal information manager 24 analyzes the pieces of distribution destination terminal information held thereby to count the number of client terminals 1 to which the advertisement information distribution device distributed advertisement information in the past one month for each of the shop IDs. The advertising company is enabled to charge an advertising cost to each of the shops which is an advertiser according to the counting results. Further, for example, the distribution destination terminal information manager 24 analyzes the pieces of distribution destination terminal information held thereby to count the number of client terminals 1 to which the advertisement information distribution device distributed advertisement information in the past one month for each of the distribution destination manufacturer IDs. The advertising company is enabled to share out a part of an advertising cost among the manufacturers of the client terminals on the basis of the distribution past records which are the counting results.

When the communicator 14 of a client terminal 1 receives advertisement information which the advertisement information distribution device 2 distributes, the advertisement information presenter 11, in step ST10, presents the advertisement information (a text, an image, a URL, etc.) to the user. After that, the position information acquirer 12, in step ST11, determines whether or not the client terminal 1 is moving on the basis of the position information. Unless the client terminal is moving (when “NO” in step ST11), the client terminal 1 ends the processing, whereas when it is determined that the movement continues (when “YES” in step ST11), the client terminal jumps to step ST4 and repeats the processing from the acquisition of the current position information to acquire advertisement information corresponding to the new current position.

Step ST10 corresponds to an advertisement information presenting step.

As mentioned above, the advertisement information distribution device 2 in accordance with Embodiment 1 is configured in such a way as to include the advertisement DB 22 to store pieces of advertisement information and pieces of position information about shops of advertisers which provide the above-mentioned pieces of advertisement information, respectively, while linking the pieces of advertisement information and the pieces of position information with each other, the advertisement information extractor 21 to extract the advertisement information of a shop existing in a predetermined range from a client terminal 1 from the advertisement DB 22 on the basis of the position information about the client terminal 1 and the pieces of position information about the shops, the communicator 23 to receive a distribution request including the position information and the manufacturer information about the client terminal 1 from the client terminal 1, and to distribute the advertisement information which the advertisement information extractor 21 extracts according to the above-mentioned position information, and the distribution destination terminal information manager 24 to hold the manufacturer information about the client terminal 1 to which the advertisement information distribution device distributes the advertisement information. Therefore, on the basis of the manufacturer information which the distribution destination terminal information manager 24 holds, the advertisement information distribution device can count the number of distributions of advertisement information for each of the manufacturers of the client terminals 1, an advertising cost corresponding to the number of distributions can be shared out among the manufacturers, and a monetary merit can be provided for each of the manufacturers. Therefore, the client terminals 1 that can present advertisement information can be made to become widespread.

Further, the advertisement information distribution device 2 in accordance with Embodiment 1 is configured in such away that the advertisement DB 22 thereof stores shop genres, and, when information specifying a shop genre is included in a distribution request which the communicator 23 receives from a client terminal 1, the distribution destination terminal information manager 24 extracts the advertisement information of a shop existing in the predetermined range from the client terminal 1 and whose genre matches the shop genre from the advertisement DB 22. Therefore, at the time of extraction of advertisement information, the advertisement information distribution device can extract the advertisement information of a shop in a specific genre in consideration of the user's taste and so on, and can perform efficient advertisement distribution.

As a client terminal 1, a display audio device or the like mounted in a moving object (e.g., a vehicle) can be used and configured in such a way as to transmit and receive information to and from the advertisement information distribution devices 2 via the mobile terminal 5, such as a mobile phone or a smart phone.

FIG. 2(b) is a block diagram showing the configuration of the mobile terminal 5 and that of a client terminal 1 in the case of using this mobile terminal 5. The client terminal 1 includes an advertisement information presenter 11 to produce a screen display or an audio output of advertisement information, a terminal information manager 13 to manage terminal information including manufacturer information, and an input/output interface 15 to transmit and receive information to and from the mobile terminal 5. A method of performing communications between the client terminal 1 and the mobile terminal 5 can be, for example, an arbitrary communication method such as short-range radio communications.

The mobile terminal 5 includes an input/output interface 51 to transmit and receive information to and from the client terminal 1, a terminal information acquirer 52 to acquire the terminal information including the manufacturer information from the client terminal 1, a position information acquirer 12 to acquire the position information about the mobile terminal 5, and a communicator 14 to communicate with the advertisement information distribution device 2 by radio. By arranging the mobile terminal 5 in the same vehicle as that in which the client terminal 1 is mounted, it can be assumed that the position information about the mobile terminal 5 which the position information acquirer 12 acquires is information equivalent to the position information about the client terminal 1. As an alternative, the client terminal 1 can have a function of acquiring the position information about itself, and notify the position information to the mobile terminal 5.

When making a request for the advertisement information of a shop existing in an area surrounding the current position of the client terminal 1, the terminal information acquirer 52 of the mobile terminal 5 acquires the terminal information about the client terminal 1 and combinedly transmits the terminal information and the current position information which the position information acquirer 12 acquires from the communicator 14 to the advertisement information distribution device 2, thereby making the advertisement information distribution request. Advertisement information distributed from the advertisement information distribution device 2 is received by the communicator 14 and is outputted to the client terminal 1 via the input/output interface 51. The client terminal 1 accepts the advertisement information by using the input/output interface 15, and the advertisement information presenter 11 presents the advertisement information to the user.

Also in the subsequent embodiment, a configuration can be provided in which each client terminal 1 and the advertisement information distribution device 2 perform direct communications with each other, or each client terminal 1 and the advertisement information distribution device 2 perform communications with each other via a mobile terminal 5.

### Embodiment 2

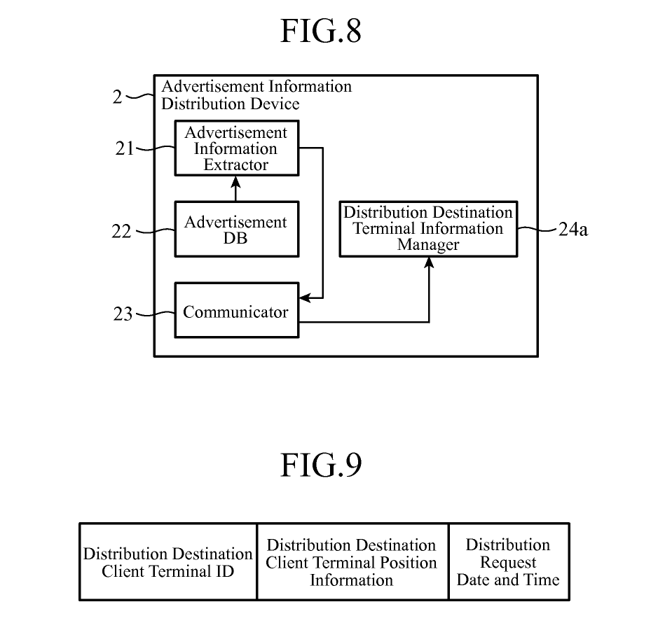

FIG. 8 is a block diagram showing the configuration of an advertisement information distribution device 2 in accordance with this Embodiment 2. In FIG. 8, the same components as those shown in FIG. 4 or like components are designated by the same reference numerals, and the explanation of the components will be omitted hereafter. Further, because an advertisement information distribution system and each client terminal 1 in accordance with this Embodiment 2 have the same configurations as the advertisement information distribution system shown in FIG. 1 and each client terminal 1 shown in FIG. 2 from a graphical viewpoint, an explanation will be made hereafter by using FIGS. 1 and 2.

FIG. 9 is a diagram showing an example of each distribution destination terminal information which a distribution destination terminal information manager 24a of the advertisement information distribution device 2 in accordance with this Embodiment 2 manages. Each distribution destination terminal information includes a distribution destination client terminal ID which is a client terminal ID included in an advertisement information distribution request transmitted from a client terminal 1, distribution destination client terminal position information which is the position information about this client terminal 1, a distribution request date and time which is a date and time when the advertisement information distribution request is accepted from this client terminal 1.

The distribution destination terminal information manager 24a uses the distribution destination client terminal ID as a key to store each distribution destination terminal information as shown in FIG. 9 and distribution destination terminal information as shown in FIG. 6 while linking them with each other.

The distribution destination terminal information manager 24a also counts the number of client terminals 1 existing in a fixed distance range from a shop on the basis of the distribution destination terminal position information of each distribution destination terminal information as shown in FIG. 9, and notifies the counting results to the shop terminal 3 of the shop. As an alternative, the distribution destination terminal information manager 24a can count the number of client terminals 1 currently existing (or existing for a period from a time from now back to the past by a fixed time) in a fixed distance range from a shop on the basis of the date and time of the distribution request of each distribution destination terminal information.

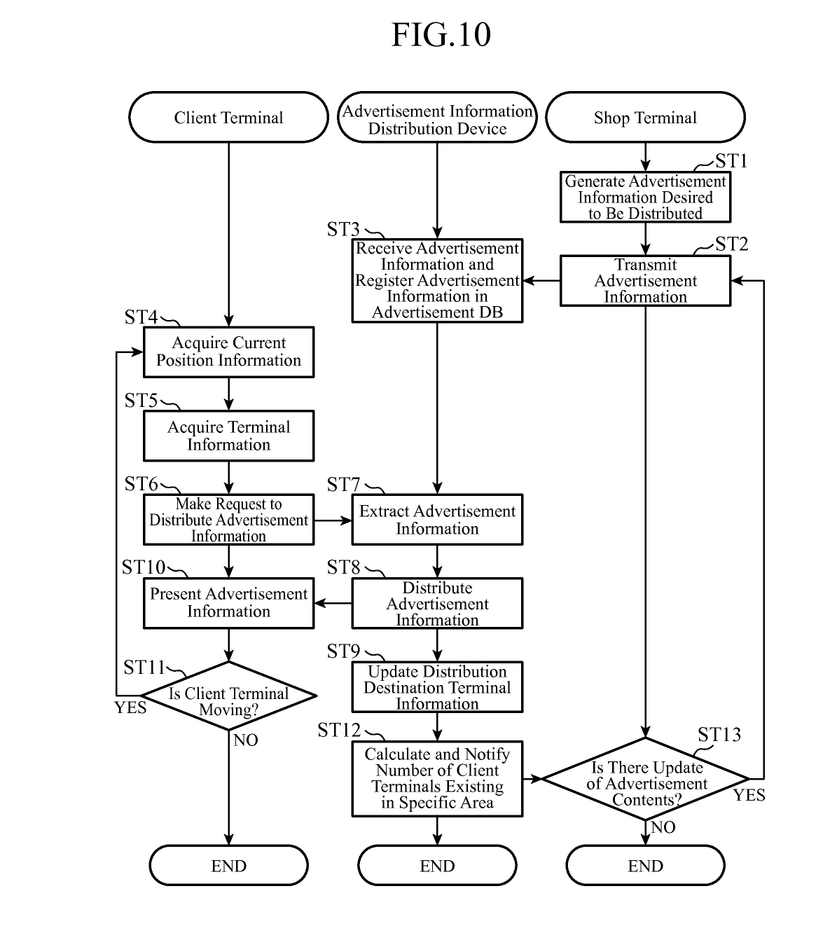

Next, the operation of the advertisement information distribution system will be explained by using a flow chart of FIG. 10. Because steps ST1 to ST8, ST10, and ST11 of FIG. 10 are the same as steps ST1 to ST8, ST10, and ST11 of FIG. 7, the explanation of the steps will be omitted hereafter and steps ST9, ST12, and ST13 specific to this Embodiment 2 will be explained.

In step ST9, the distribution destination terminal information manager 24a of the advertisement information distribution device 2 holds pieces of distribution destination terminal information (e.g., that shown in FIG. 6) each including the terminal information about a distribution destination (including at least a manufacturer ID, client terminal position information, and a distribution request date and time), and the shop information about a shop terminal 3 which has provided advertisement information distributed.

Next, the distribution destination terminal information manager 24a, in step ST12, analyzes the shop information about a specific shop and the pieces of distribution destination terminal information held thereby, counts the number of client terminals 1 existing in a fixed distance range from the position where the shop exists, and transmits the counting results to the shop terminal 3 of the shop via the communicator 23. As a result, each advertiser can grasp how many client terminals 1 to which the advertisement information can be distributed exist in an area surrounding its shop. Each advertiser determines whether or not there is a necessity to update the advertisement contents on the basis of the counting results, and updates the advertisement information if necessary.

The shop terminal 3 jumps to step ST2 when there is an update of the advertisement information (when “YES” in step ST13), and transmits the updated advertisement information to the advertisement information distribution device 2. In contrast, where there is no update of the advertisement information (“NO” in step ST13), the shop terminal 3 ends the processing.

As a result, for example, a shop that desires to temporarily entice customers to come therein when the number of seats available is sufficiently large, a shop that desires to entice customers to come therein because of a surplus of foodstuffs even if lowering food prices, or the like is enabled to generate advertisement information showing a time sale, such as “20% OFF Tuna Nigiri Sushi, Today 20:00-21:00, Limited to the First 10 Couples”, and efficiently distribute the advertisement information by way of the advertisement information distribution device 2.

As mentioned above, in accordance with Embodiment 2, the distribution destination terminal information manager 24a of the advertisement information distribution device 2 is configured in such a way as to hold the pieces of position information about client terminals 1 to which the advertisement information distribution device distributes advertisement information, and extracts a client terminal 1 existing in a predetermined range from a shop on the basis of the pieces of position information held thereby, and the communicator 23 is configured in such a way as to transmit information about the client terminal 1 which the distribution destination terminal information manager 24a extracts to the shop terminal 3 of the shop. When client terminals 1 which are targets for advertisement display, like navigation devices intended for vehicles, and mobile terminals, such as mobile phones or smart phones, are moving, by providing the number of client terminals 1 moving in the neighborhood of a shop for the advertiser of the shop, the advertiser is enabled to determine whether or not there is a merit in distributing real time advertisement information such as time sale information, and the advertisement information distribution device can carry out efficient advertisement distribution.

In contrast with this, when using any of the methods disclosed in patent references 1 to 3 which are explained previously, because the number of client terminals existing in a specific area is unknown, no advertisement distribution can be carried out efficiently in response to a shop's request to distribute real time advertisement information.

Although in above-mentioned Embodiment 2, the distribution destination terminal information manager 24a counts the number of client terminals 1 existing in an area surrounding a shop on the basis of the distribution destination client terminal position information included in the distribution destination terminal information, the present embodiment is not limited to this example. For example, each client terminal 1 or the advertisement information distribution device 2 can search for a route to a destination to which the user carrying the client terminal 1 desires to go, and the distribution destination terminal information manager 24a can predict not only the position of the client terminal 1 at the distribution request date and time included in distribution destination terminal information, but also that at a time after the distribution request date and time, on the basis of the route, and count the number of client terminals 1 existing in an area surrounding a shop at a certain date and time and notify the number of client terminals to the shop terminal 3 of the shop.

While the invention has been described in its preferred embodiments, it is to be understood that, in addition to the above-mentioned embodiments, an arbitrary combination of two or more of the embodiments can be made, various changes can be made in an arbitrary component according to any one of the embodiments, and an arbitrary component according to any one of the embodiments can be omitted within the scope of the invention.

### INDUSTRIAL APPLICABILITY

As mentioned above, because the advertisement information distribution device in accordance with the present invention manages the manufacturer information about a client terminal to which the advertisement information distribution device distributes advertisement information, the advertisement information distribution device is suitable for use as an advertisement information distribution device that distributes advertisement information to mobile terminals, navigation devices, etc.

### EXPLANATIONS OF REFERENCE NUMERALS

1 client terminal, 2 advertisement information distribution device, 3 shop terminal, 4 network, 5 mobile terminal, 11 advertisement information presenter, 12 position information acquirer, 13 terminal information manager, 14 communicator, 15 and 51 input/output interface, 21 advertisement information extractor, 22 advertisement DB, 23 communicator, 24 and 24a distribution destination terminal information manager, and 52 terminal information acquirer.

1. An advertisement information distribution device that can communicate with client terminals, said advertisement information distribution device comprising:
an advertisement database to store pieces of advertisement information and pieces of position information about facilities of advertisers which provide said pieces of advertisement information, respectively, while linking said pieces of advertisement information and said pieces of position information with each other;
an advertisement information extractor to extract advertisement information of said facility existing in a predetermined range from said client terminal from said advertisement database on a basis of position information about said client terminal and the pieces of position information about said facilities;
a communicator to receive a distribution request including the position information about said client terminal and manufacturer information showing a manufacturer of said client terminal from said client terminal, and to distribute the advertisement information which said advertisement information extractor extracts according to said position information; and
a distribution destination terminal information manager to hold the manufacturer information about said client terminal to which said advertisement information distribution device distributes the advertisement information.

2. The advertisement information distribution device according to claim 1, wherein said distribution destination terminal information manager counts a number of distributions of advertisement information for each of the manufacturers of said client terminals on a basis of said manufacturer information held thereby.

3. The advertisement information distribution device according to claim 1, wherein said distribution destination terminal information manager holds the position information about said client terminal to which said advertisement information distribution device distributes the advertisement information, and extracts said client terminal existing in a predetermined range from said facility on a basis of said position information held thereby, and said communicator transmits information about said client terminal which the said distribution destination terminal information manager extracts to a terminal device of said facility.

4. The advertisement information distribution device according to claim 1, wherein said advertisement database stores genres of said facilities, and, when information specifying the genre of said facility is included in the distribution request which the said communicator receives from said client terminal, said advertisement information extractor extracts the advertisement information of said facility existing in the predetermined range from said client terminal and whose genre matches the genre of said facility from said advertisement database.

5. A client terminal that can communicate with an advertisement information distribution device that distributes advertisement information in response to a distribution request from each of client terminals, and counts a number of distributions of advertisement information for each of manufacturers of these client terminals, said client terminal comprising:
a position information acquirer to acquire position information about said client terminal itself;
a terminal information manager to store manufacturer information showing a manufacturer of said client terminal itself;
a communicator to transmit the position information which said position information acquirer acquires and the manufacturer information which said terminal information manager stores to said advertisement information distribution device, and to make a request to distribute advertisement information of a facility existing in a predetermined range from said client terminal itself, and to receive the advertisement information which is distributed thereto from said advertisement information distribution device in response to said request; and
an advertisement information presenter to present the advertisement information which said communicator receives.

6. (canceled)

7. An advertisement information presenting method for a client terminal that can communicate, via a mobile terminal, with an advertisement information distribution device that distributes advertisement information in response to a distribution request from each of client terminals, and counts a number of distributions of advertisement information for each of manufacturers of these client terminals, said advertisement information presenting method comprising:
a position information acquiring step of said mobile terminal acquiring the position information about said client terminal;
an advertisement information distribution requesting step of said mobile terminal acquiring manufacturer information showing the manufacturer of said client terminal from said client terminal, transmitting the manufacturer information to said advertisement information distribution device together with the position information acquired in said position information acquiring step, and making a request to distribute advertisement information of a facility existing in a predetermined range from said client terminal;
an advertisement information receiving step of said mobile terminal receiving the advertisement information which is distributed thereto from said advertisement information distribution device in response to said request; and
an advertisement information presenting step of said mobile terminal outputting the advertisement information received in said advertisement information receiving step to said client terminal, and said client terminal presenting the advertisement information.
